(19) United States
(12) Patent Application Publication
(10) Pub. No.: US 2026/0105581 A1
(43) Pub. Date: Apr. 16, 2026

(54) IMAGE COMPOSITION OF MULTIPLE OBJECTS USING GENERATIVE MODELS

(71) Applicant: Microsoft Technology Licensing, LLC, Redmond, WA (US)

(72) Inventors: Balasaravanan Thoravi KUMARAVEL, Bellevue, WA (US); Andrew D. WILSON, Seattle, WA (US); Keng-Hao CHANG, San Jose, CA (US); Mithun Das GUPTA, Cupertino, CA (US); Raveena KSHATRIYA, San Francisco, CA (US); Qun LI, Lake Forest Park, WA (US); Jialu GAO, Pittsburgh, PA (US)

(73) Assignee: Microsoft Technology Licensing, LLC, Redmond, WA (US)

(21) Appl. No.: 18/915,915

(22) Filed: Oct. 15, 2024

(51) Int. Cl. G06T 5/77; G06T 5/50; G06T 5/60; G06T 11/60; G06T 19/00

(52) U.S. Cl. CPC G06T 5/77; G06T 5/50; G06T 5/60; G06T 11/60; G06T 19/00; G06T 2207/20084; G06T 2207/20221

(57) ABSTRACT

This document relates to generation of new images from input images depicting different objects. For instance, the disclosed techniques can generate a layout that specifies locations of the objects. Then, a canvas can be generated depicting the objects in the specified locations. A generative image model can be employed to inpaint areas of the canvas around the depicted objects, while the objects themselves retain their original appearance from the input images.

### BACKGROUND

One important use case for computing devices involves image generation using a generative image model. For instance, generative image models can generate new images based solely on textual prompts. Generative image models can also modify existing images by adding new image content to the existing images. However, there are some use cases where generative image models can modify existing images in a manner that produces undesirable results.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for generating images using generative image models. One example includes a computer-implemented method that can include receiving a first input image depicting a first object. The method can also include receiving a second input image depicting a second object. The method can also include obtaining a layout specifying a first location of the first object and a second location of the second object. The method can also include generating a canvas having the first object in the first location and the second object in the second location. The method can also include providing, to a generative image model, a request to inpaint the canvas while retaining the first object and the second object. The method can also include receiving a generated image from the generative image model. The method can also include outputting the generated image.

Another example entails a system that includes a processor and a storage medium storing instructions. When executed by the processor, the instructions can cause the system to receive a first input image depicting a first object. The instructions can also cause the system to receive a second input image depicting a second object. The instructions can also cause the system to obtain a layout specifying a first location of the first object and a second location of the second object. The instructions can also cause the system to generate a canvas having the first object in the first location and the second object in the second location. The instructions can also cause the system to provide, to a generative image model, a request to inpaint the canvas while retaining the first object and the second object. The instructions can also cause the system to receive a generated image from the generative image model. The instructions can also cause the system to output the generated image.

Another example includes a computer-readable storage medium storing executable instructions which, when executed by a processor, cause the processor to perform acts. The acts can include receiving a first input image depicting a first object. The acts can also include receiving a second input image depicting a second object. The acts can also include obtaining a layout specifying a first location of the first object and a second location of the second object. The acts can also include generating a canvas having the first object in the first location and the second object in the second location. The acts can also include providing, to a generative image model, a request to inpaint the canvas while retaining the first object and the second object. The acts can also include receiving a generated image from the generative image model. The acts can also include outputting the generated image.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example generative language model, consistent with some implementations of the present concepts.

FIG. 2 illustrates an example generative image model, consistent with some implementations of the present concepts.

FIG. 3 illustrates an example vision language model, consistent with some implementations of the present concepts.

FIG. 4 illustrates an example image generation pipeline for layout-based generation of images, consistent with some implementations of the present concepts.

FIG. 5 illustrates an example of a viewpoint compatibility checking process, consistent with some implementations of the present concepts.

FIG. 6 illustrates example pairs of input images having compatible viewpoints for subsequent image generation, consistent with some implementations of the present concepts.

FIGS. 7A and 7B illustrate examples of obtaining masks from objects shown in input images, consistent with some implementations of the present concepts.

FIG. 8 illustrates examples of canvases obtained from layouts of objects shown in input images, consistent with some implementations of the present concepts.

FIG. 9 illustrates examples of generated images produced from layouts, consistent with some implementations of the present concepts.

FIG. 10 illustrates an example of a graphical user interface, consistent with some implementations of the present concepts.

FIG. 11 illustrates an example of a system in which the disclosed implementations can be performed, consistent with some implementations of the present concepts.

FIG. 12 illustrates an example method or technique, consistent with some implementations of the disclosed techniques.

### DETAILED DESCRIPTION

### Overview

As noted above, generative image models can be employed to generate new images from existing images. However, the resulting images sometimes present content from the existing images in a manner that is not ideal. For instance, consider using a generative image model to generate a new image from existing images of objects, such as an existing image of a table and another existing image of a bowl. A generative image model may tend to generate an unnatural image that does not accurately convey the relative sizes of the table and the bowl. In addition, a user may wish to feature the table and the bowl in a natural layout, e.g., with the bowl sitting on the table. However, a generative image model may sometimes generate an image with an unnatural layout, e.g., with the bowl sitting on the floor instead of on the table. In addition, a generative image model might alter the appearance of the bowl or table, whereas in some cases users may prefer to retain the appearance of the bowl and table from the original images. Complicating matters further, objects are sometimes captured from different viewpoints and, in some cases, it is not feasible to generate a realistic image showing objects from their original viewpoints.

The disclosed implementations can employ generative image models to create new images that include objects shown in different input images, where the objects are shown in a natural layout while retaining their original appearance. For instance, an image generation pipeline can involve segmenting objects from original input images and determining respective sizes of the objects. Then, a layout of the objects can be generated that specifies locations of the objects and relative sizes of the objects. Then, a canvas can be produced from the layout and provided to a generative image model with a theme. The generative image model perform inpainting of the canvas based on the theme to achieve a final generated image that shows the objects in an environment that visually conveys the specified theme. The image generation pipeline achieves generated images that are authentic to size and camera angle of the objects as depicted in the original input images, without substantially altering their appearance. Said another way, the generative image model can alter the background of the canvas according to the specified theme while retaining the original appearance of the objects.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chamelon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Decoder-Based Generative Language Model

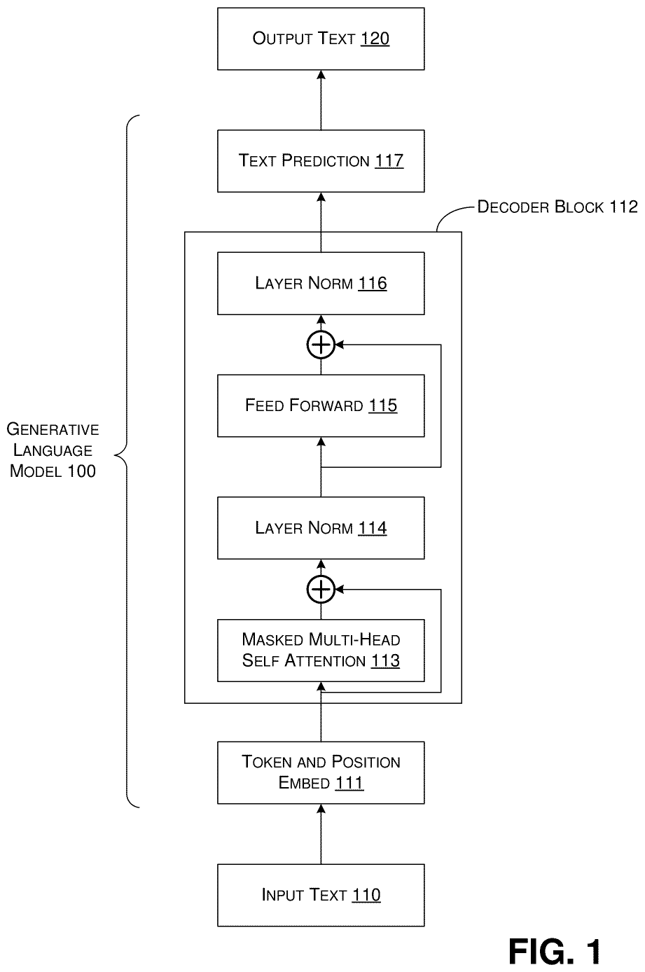

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or a prompt generated automatically by machine learning using the disclosed techniques. For instance, the input text can include words, sentences, phrases, or other representations of language. As discussed more below, in some implementations, the input text can characterize input images. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model. As discussed more below, in some implementations, the output text can include image generation prompts for completing a three-dimensional virtual space based on one or more input images.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents (Radford, et al., “Improving language understanding by generative pre-training,” 2018). In some cases, a generative language model can be trained to predict multiple output tokens in a single inference step (Gloeckle, et al., “Better & faster large language models via multi-token prediction,” Apr. 30, 2024, arXiv preprint arXiv:2404.19737). After pretraining, generative language model can be tuned using a reinforcement learning technique such as reinforcement learning from human feedback (“RLHF”). As discussed more below, generative language model 100 can also be conditioned using in-context techniques to generate layouts of objects in two-or three-dimensional spaces.

### Example Generative Image Model

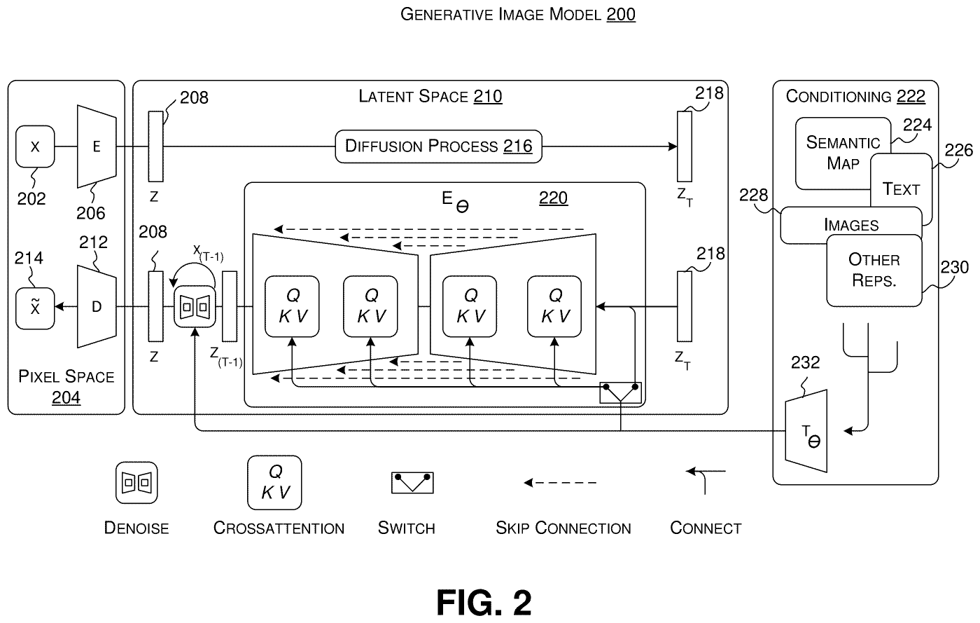

FIG. 2 illustrates an example generative image model 200. An image 202 (X) in pixel space 204 (e.g., red, green, blue) is encoded by an encoder 206 (E) into a representation 208 (Z) in a latent space 210. A decoder 212 (D) is trained to decode the latent representation Z to produce a reconstructed image 214 (X˜) in the pixel space. For instance, the encoder can be trained (with the decoder) as a variational autoencoder using a reconstruction loss term with a regularization term.

In the latent space 210, a diffusion process 216 adds noise to obtain a noisy representation 218 (Z_{T}). A denoising component 220 (E_{θ}) is trained to predict the noise in the compressed latent image Z_{T}. The denoising component can include a series of denoising autoencoders implemented using UNet 2D convolutional layers.

The denoising can involve conditioning 222 on other modalities, such as a semantic map 224, text 226, images 228, or other representations 230 which can be processed to obtain an encoded representation 232 (T_{θ}). For instance, text (e.g., an image generation prompt) can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 200 can be employed for text to image generation, where an image is generated from a text prompt. Text prompts can be provided by users or generated automatically by machine learning using the disclosed techniques. In other cases, generative image model 200 can be employed for image-to-image mode, where an image is generated using an input image as well as a user or machine-generated text prompt. Generative image model 200 can also be employed for inpainting, where parts of an image remain fixed while the rest of the image is generated by the model, in some cases conditioned on a user or machine-generated text prompt.

In some cases, generative image model 200 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 200, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image. As described more below, the resulting images can be employed to provide three-dimensional virtual spaces based on input images received from users.

### Generative Modes

Generative image model 200 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting mode, the processing is similar to the image-to-image mode, but an image mask is used to determine which parts of the image are modified and which parts of the image remain fixed. The masked portion of the image is generated in a way that it is consistent with the fixed portion of the image, which remains unmodified.

### Example Vision Language Model

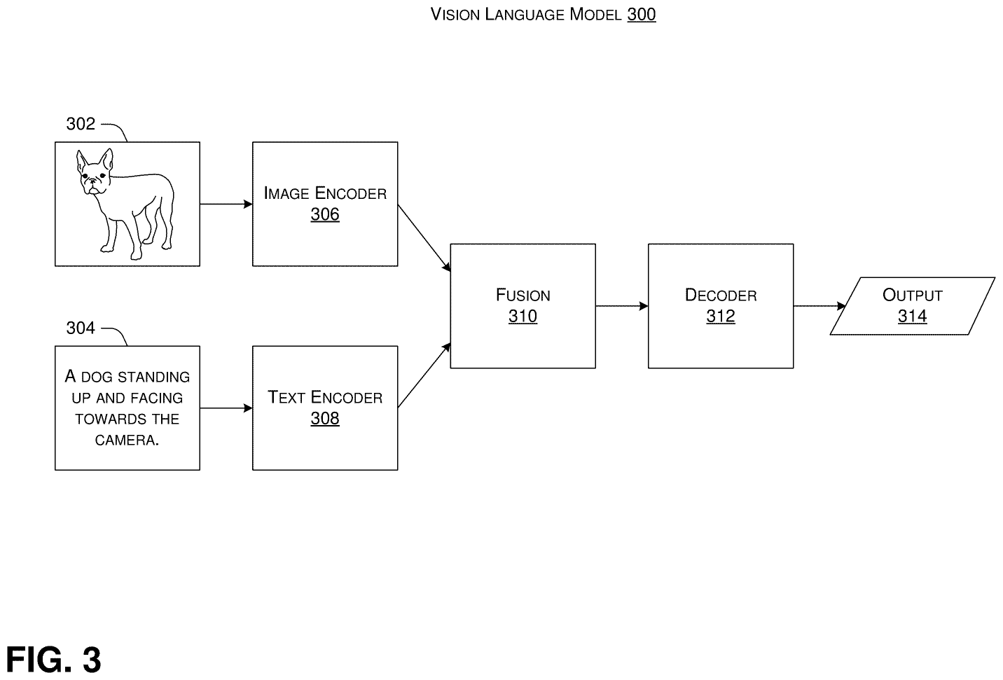

FIG. 3 shows an example vision language model 300 that can process an input image 302 and/or a text input 304. The input image is processed using an image encoder 306 and the text input is processed using a text encoder 308. The image encoder and text encoder produce encodings (e.g., vector embeddings) representing the input image and text input, respectively. A fusion process 310 can fuse the encodings using techniques such as attention, dot product, etc. A decoder 312 can decode the fused encodings to produce an output 314.

In some implementations, the image encoder 306 can be based on a convolutional architecture, such as ResNet. He, et al., “Deep Residual Learning for Image Recognition,” in Proceedings of the IEEE Conference on Computer Vision and Pattern Recognition, 2016, pp. 770-778. The image encoder can also based on a transformer architecture such as Vision Transformer. The text encoder 308 can be based on a transformer architecture such as BERT or GPT. In other cases, an “early fusion” approach can employ a shared encoder that processes sequences of text and image tokens using a single encoder that determines embeddings for each text or image token, as in Chameleon. Team C, “Chameleon: Mixed-modal early-fusion foundation models,” 2024, arXiv preprint, arXiv:2405.09818.

The vision language model 300 can be trained using approaches such as contrastive learning, where the training data includes pairs of text and images and the model is trained to determine whether a given text sample matches a corresponding image sample. In this manner, the image encoder 306 and the text encoder 308 can be trained to generate similar embeddings for text and images that represent similar concepts (e.g., the word “bear” and an image of a bear). Other approaches include masked image modeling and/or masked language modeling and image-text modeling.

The output 314 can characterize an image. For instance, the output can answer a visual question, caption the image, etc. The output can also identify detected objects, classify detected objects, perform image segmentation, etc. As discussed more below, in some cases, the vision language model 300 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc.

### Example Pipeline

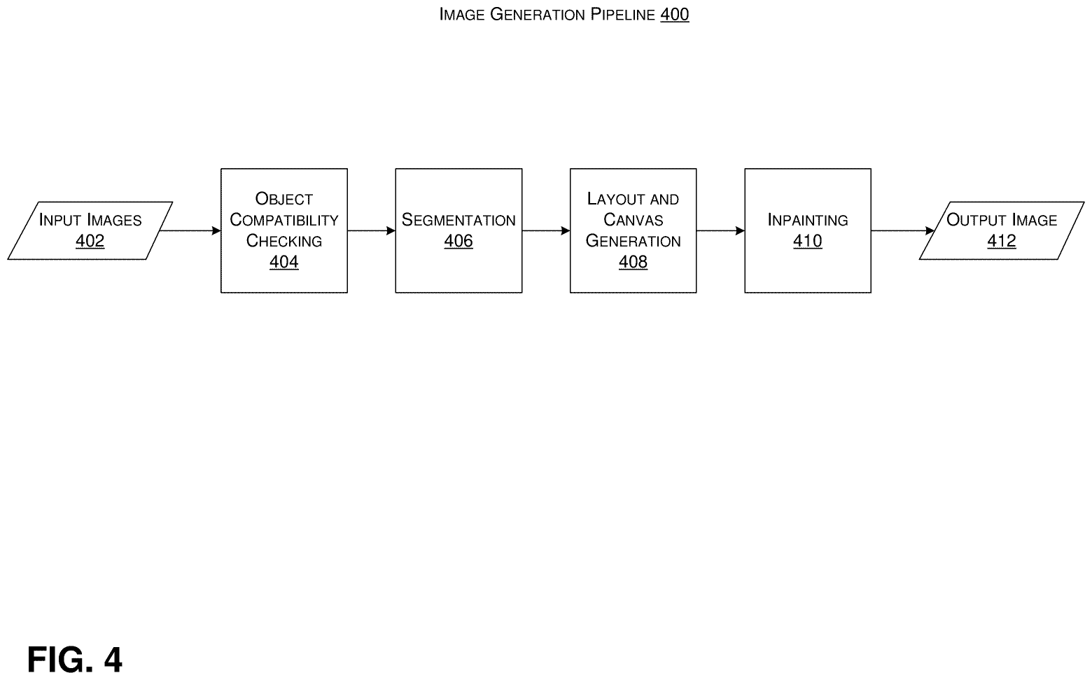

FIG. 4 shows an example image generation pipeline 400 that can be used to implement the present concepts. Input images 402 are processed using object compatibility checking 404, which can involve detecting when objects are shown in the input images from incompatible viewpoints. Segmentation 406 is employed to obtain segmentations of objects from input images, and then the resulting segmentations can be used to obtain masks of the objects. Layout and canvas generation 408 generates a layout that specifies locations and sizes of the objects and then produces a canvas showing the objects in the specified locations with the specified sizes. Inpainting 410 produces output image(s) 412 by inpainting masked (e.g., background) areas of the generated canvases, and can be conditioned on a user-specified theme. Each stage of image generation pipeline 400 is described in more detail below.

### Example Object Compatibility Checking

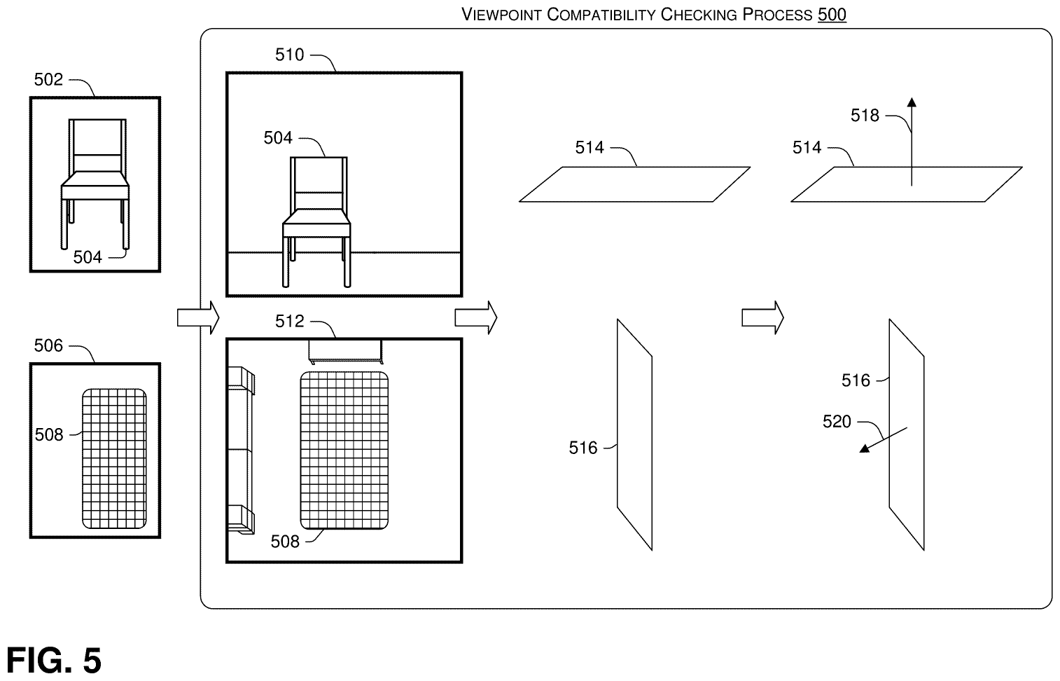

Object compatibility checking 404 can involve evaluating images to check whether objects depicted in the images are shown from compatible viewpoints. FIG. 5 shows a viewpoint compatibility checking process 500 that can be employed in this regard. A first image 502 shows a first object, a chair 504, and a second image 506 shows a second object, a floormat 508. As can be seen from FIG. 5, the chair is shown from a frontal view while the floormat is shown from a top-down view. An image generation model provided images of these two objects from these viewpoints could produce an unnatural result, e.g., showing the floormat against a wall. The following describes how viewpoint estimation can be employed to detect pairs of objects shown from incompatible viewpoints so that they can be excluded from subsequent image generation.

One way to estimate the viewpoint for each object is to estimate the orientation of a floor relative to each depicted object. However, note that the input images depict only the objects themselves, without showing a floor. One way to estimate the viewpoint is to provide the images to generative image model 200. The generative image model can inpaint a background around the objects shown in each respective image, resulting in generated images 510 and 512. The generated images show the chair 504 and floormat 508 in context with a floor that was inpainted by the generative image model. Because the generative image model has been trained to show chairs and floormats in appropriate contexts, the generative image model can produce images that show reasonable placement of the objects on a floor from an appropriate view angle, together with other objects seen from the same angle.

A first floor plane 514 can be obtained from generated image 510 and a second floor plane 516 can be obtained from generated image 512. The floor planes can be obtained by performing depth estimation on the generated (e.g., 2D) images to obtain 3D point clouds. A first up vector 518 can be obtained from the first floor plane 514 and a second up vector 520 can be obtained from the second floor plane 516, where the up vector represents the direction of the floor plane.

The viewpoint compatibility checking process 500 can involve determining whether the up vectors are within a threshold angle of one another (e.g., cosine similarity). Here, the chair 504 is shown from a frontal view while the floormat 508 is shown from a top-down view. Thus, in this case, the chair 504 and floormat 508 are designated as objects that are not paired together for image generation.

Note that other approaches can also be employed for viewpoint compatibility checking. In some cases, a vision language model could be trained to determine the viewpoints of objects shown in a given input image. In other cases, metadata associated with a given input image could convey the viewpoint angle.

### Example Compatible Image Pairs

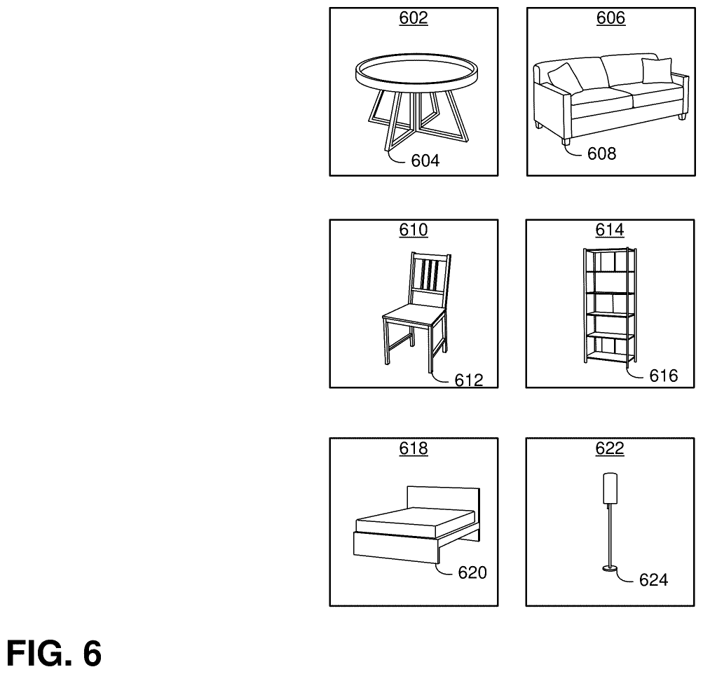

FIG. 6 shows example pairs of input images having respective objects that are deemed compatible by object compatibility checking 404 of image generation pipeline 400. Input image 602 shows a table 604 and input image 606 shows a sofa 608. The table and sofa can be paired together during object pairing for subsequent generation of an image that includes both the table and the sofa. Input image 610 shows a chair 612 and input image 614 shows a bookshelf 616. The chair and bookshelf can be paired together during object pairing for subsequent generation of an image that includes both the chair and the bookshelf. Input image 618 shows a bed 620 and input image 622 shows a lamp 624. The bed and the lamp can be paired together during object pairing for subsequent generation of an image that includes both the bed and the lamp.

Note that the input images in FIG. 6 show objects in isolation, e.g., without backgrounds, people, or other objects. In some cases, objects are shown in isolation to feature the visual characteristics of the objects without distracting backgrounds or other objects. As described more below, image generation pipeline 400 can allow for generation of new images that show objects taken from different input images in a realistic setting without modifying the appearance of the objects as shown in the original input images.

### Example Segmentations

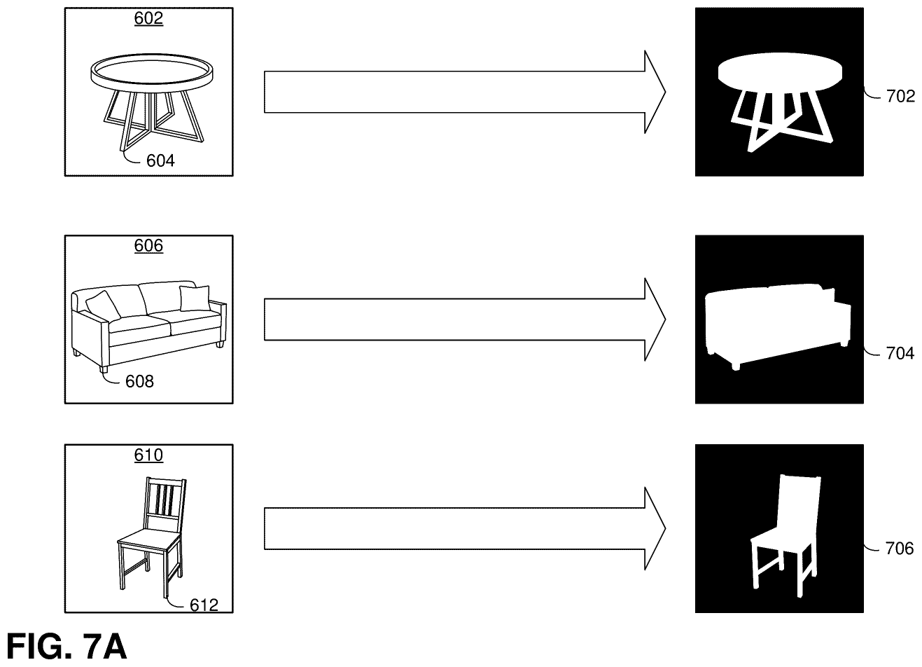

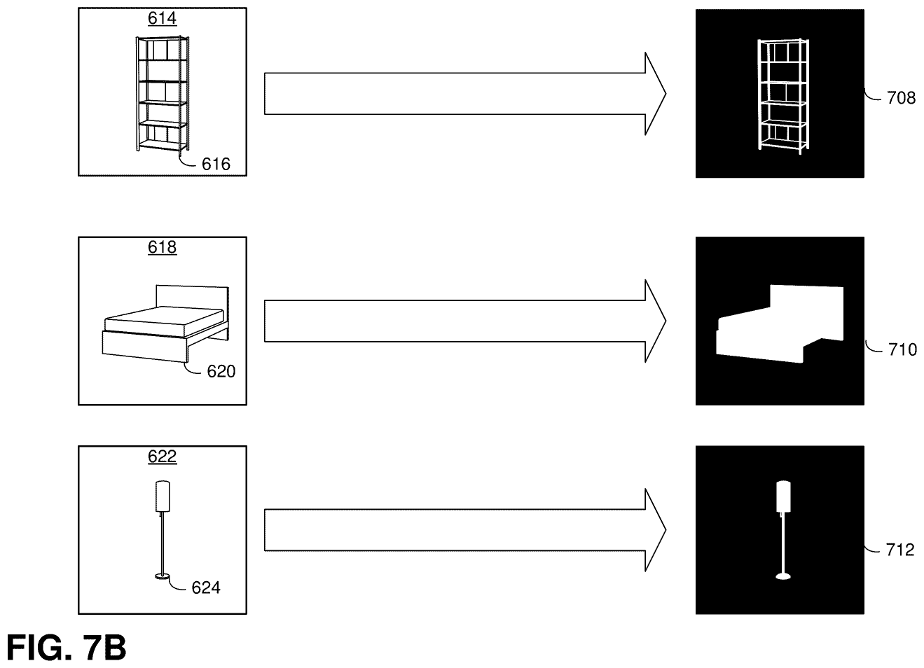

Segmentation 406 of image generation pipeline 400 can involve determining segmentations and corresponding masks for each of the objects in the input images. FIGS. 7A and 7B show examples of masks that can be derived for each of the objects shown in the input images. FIG. 7A shows a mask 702 obtained from image 602, which masks off the pixels of table 604, a mask 704 obtained from image 606, which masks off the pixels of sofa 608, and a mask 706 obtained from input image 610, which masks off the pixels of chair 612. FIG. 7B shows a mask 708 obtained from input image 614, which masks off the pixels of bookshelf 616, a mask 710 obtained from input image 618, which masks off the pixels of bed 620, and a mask 712 obtained from input image 622, which masks off the pixels of lamp 624.

One way to obtain the masks involves inputting the respective input images to vision language model 300. The vision language model can output a description of the object depicted in each input image. For instance, the vision language model could output “table with round top” for input image 602, “sofa with two pillows” for image 606, and so on. Then, the descriptions can be input to a detection and segmentation model that identifies and produces segmentations of the described objects. One specific model that can be employed is Grounded SAM, described at Ren, et al., “Grounded SAM: Assembling open-world models for diverse visual tasks,” Jan. 25, 2024, arXiv preprint arXiv:2401.14159.

### Example Layouts and Canvases

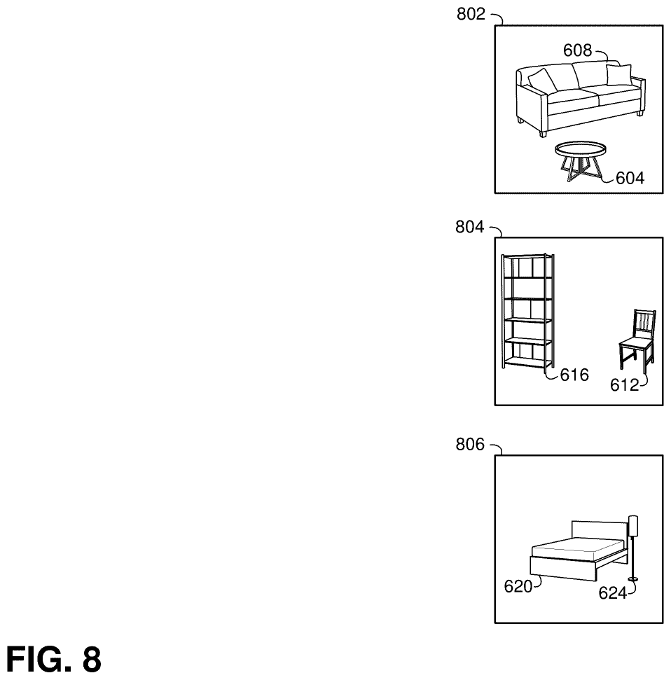

Layout and canvas generation 408 of image generation pipeline 400 can involve generating layouts for placement of the objects in realistic scenes. The layouts can specify locations and sizes of the respective objects, and can be generated using a number of techniques discussed more below. Once the layouts are determined, two-dimensional canvases can be generated by placing the objects in a two-dimensional image at the locations specified by the respective layouts. FIG. 8 illustrates an example canvas 802 with table 604 and sofa 608, an example canvas 804 with chair 612 and bookshelf 616, and an example canvas 806 with bed 620 and lamp 624.

First, the dimensions of each object can be determined. In some cases, the input images themselves may be associated with object descriptions that convey the size of a given object. For instance, if image 614 is obtained from a product catalog with a description of the bookshelf 616, e.g., “mahogany bookshelf, 6 feet tall, 4 feet wide, 2 feet deep,” then the dimensions can be extracted from the catalog. As another example, generative language model 100 can be queried to determine if the dimensions can be obtained from an image source, such as a URL, using a prompt such as “Prompt: Can you tell the dimension of the furniture in the following link. Answer by giving only: length×width×height in cm. Here is the link: <url>.” A third approach for estimating sizes of the depicted objects involves employing a trained machine learning model such as Metric3D. Yin, et al., “Metric3d: Towards zero-shot metric 3d prediction from a single image,” 2023, In Proceedings of the IEEE/CVF International Conference on Computer Vision (pp. 9043-9053).

The sizes of the respective paired objects can then be used to generate a layout. One way to generate a layout is to use a layout generation model, such as LayoutGPT. Feng, et al., “Layoutgpt: Compositional visual planning and generation with large language models,” 2024, Advances in Neural Information Processing Systems, 36. For instance, generative language model 100 can be prompted with example layouts, and can generate new layouts based on the examples. The example layouts and/or generated layouts can include locations, widths, and heights of objects (for 2D or 3D layouts) as well as depth and orientation for 3D layouts.

Thus, for instance, a prompt such as “a round table in front of a sofa” could be input to generative language model 100. The generative language model could output, in response, a layout specifying locations, widths, heights, depths, and/or orientations for the sofa and table, as depicted in canvas 802. Similarly, a prompt such as “a bookcase and a chair sitting next to one another” could be input to generative language model. The generative language model could output, in response, a layout specifying locations, widths, heights, depths, and/or orientations for the bookcase and chair, as depicted in canvas 804. Likewise, a prompt such as “a standing lamp next to a queen bed” could be input to generative language model. The generative language model could output, in response, a layout specifying locations, widths, heights, depths, and/or orientations for the bed and lamp, as depicted in canvas 806.

Note that other techniques can also be employed to generate layouts. For instance, consider a repository with thousands of images of furniture shown in various contexts. A machine learning model, such as a neural network, could be trained on the image repository to output layouts. For instance, objects in images could be classified as beds, sofas, tables, using a model such as ResNet or a vision language model. Then, bounding boxes could be determined using a model such as Faster-RCNN (Ren, et al., “Faster R-CNN: Towards real-time object detection with region proposal networks,” 2016, IEEE transactions on pattern analysis and machine intelligence, 39(6), 1137-1149). At inference time, convolutional neural network could be trained to output bounding boxes of different types of furniture after having been trained on arrangements of furniture in the repository. In further implementations, the repository could include synthetic training images that show objects, such as furniture, arranged relative to one another as generated by a generative image model. Because generative image models are trained on real images of objects shown in natural locations relative to one another, such synthetic images are also likely to show objects of different types in appropriate arrangements.

### Example Generated Images

Inpainting 410 of image generation pipeline 400 can involve inpainting canvases produced from the generated layouts using generative image model 200, where the inpainting is conditioned on a theme. Each layout can be used to create a corresponding canvas where the objects are positioned in the canvas according to the layout. A mask can be applied to the rest of the canvas so that the generative image model can inpaint the masked area while retaining the objects with their original appearance from the input images.

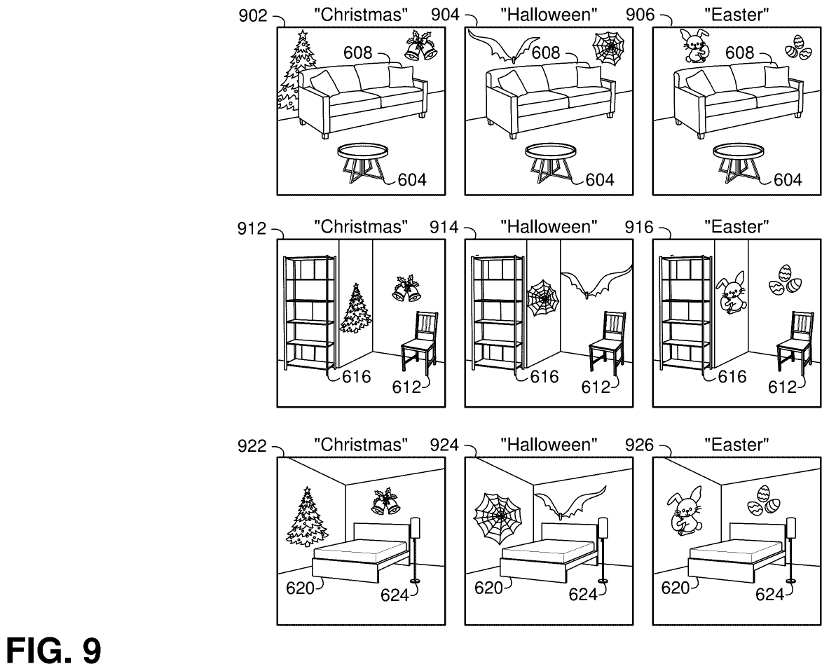

FIG. 9 shows examples of generated images produced from canvas 802. Image 902 is generated from canvas 802 with a Christmas theme, image 904 is generated from canvas 802 with a Halloween theme, and image 906 is generated from canvas 802 with an Easter theme. Note that the table 604 and sofa 608 are positioned relative to one another in the same locations in each of the generated images, and the appearance of the table and sofa are unaltered relative to input images 602 and 606, from which they were respectively obtained. The remainder of the generated images, however, has been inpainted differently to match the corresponding themes.

Image 912 is generated from canvas 804 with a Christmas theme, image 914 is generated from canvas 804 with a Halloween theme, and image 916 is generated from canvas 804 with an Easter theme. Note that the chair 612 and bookshelf 616 are positioned relative to one another in the same locations in each of the generated images, and the appearance of the chair and bookshelf are unaltered relative to input image 610 and input image 614, from which they were respectively obtained. The remainder of the generated images, however, has been inpainted differently to match the corresponding themes.

Image 922 is generated from canvas 806 with a Christmas theme, image 924 is generated from canvas 806 with a Halloween theme, and image 926 is generated from canvas 806 with an Easter theme. Note that the bed 620 and lamp 624 are positioned relative to one another in the same locations in each of the generated images, and the appearance of the bed and lamp are unaltered relative to input images 618 and 622, from which they were respectively obtained. The remainder of the generated images, however, has been inpainted differently to match the corresponding themes.

In some implementations, the appearance of the objects can be preserved by controlling the generative image model 200 according to various constraints. For instance, the generative image can be instructed to preserve edges of the respective objects from the canvas that is input to the generative image model. This prevents the generative image model from altering the outline of the objects themselves. The generative image model can also be instructed to preserve the depth of the respective objects from the canvas. This prevents the generative image model from altering the relative two depths of the objects and instead preserves the relative depths specified by the canvas.

### Example GUI

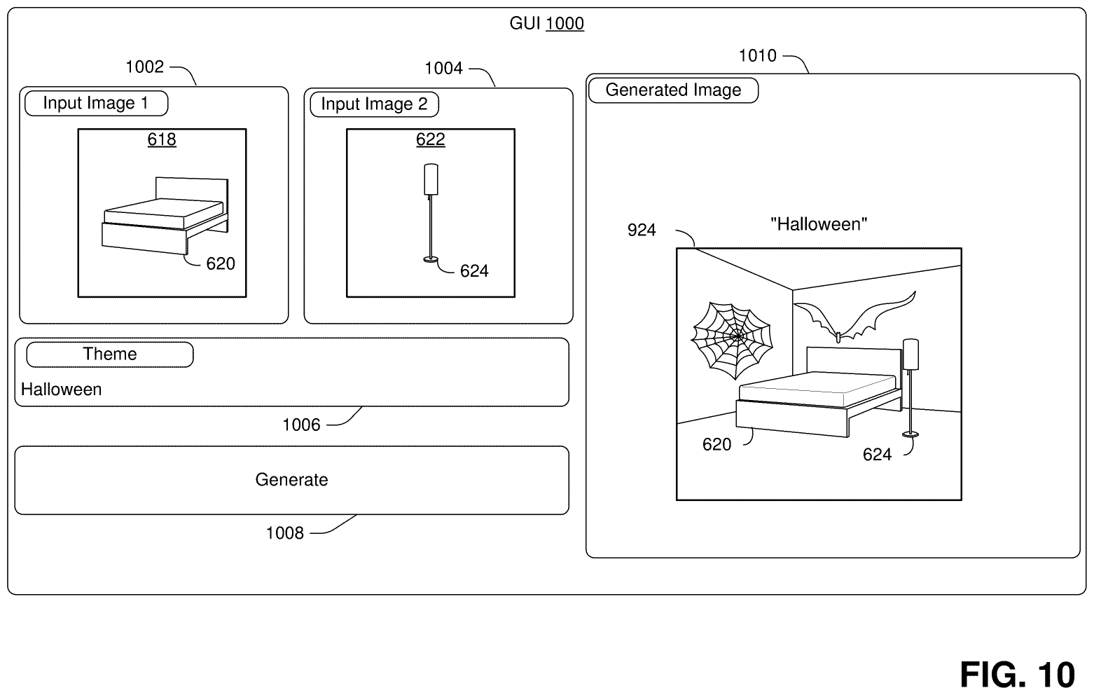

FIG. 10 shows a GUI 1000 that can be employed by a user to configure image generation pipeline 400. Input image element 1002 allows a user to select a first input image and input image element 1004 allows the user to select a second input image. Here, the user has selected image 618 as the first input image and image 622 as the second input image. Theme element 1006 allows the user to select a theme for image generation. Here, the user has entered the term “Halloween.” Generate element 1008 allows the user to trigger image generation. Generated image element 1010 shows the generated image.

In some implementations, the GUI 1000 can be employed to output a message to the user indicating when two input images are incompatible. For instance, referring back to FIG. 5, if the user selected images 502 and 506 for image generation, a warning or error message could be output indicating that the images show objects from incompatible viewpoints. The user can be given an option to navigate to one or more other images. In other cases, user images can be preprocessed to sort images into groups that have compatible viewpoints. If the user selects a first image using input image element 1002, then selecting input image element 1004 can navigate to a filtered subset of images that have compatible viewpoints with the first image.

### Example System

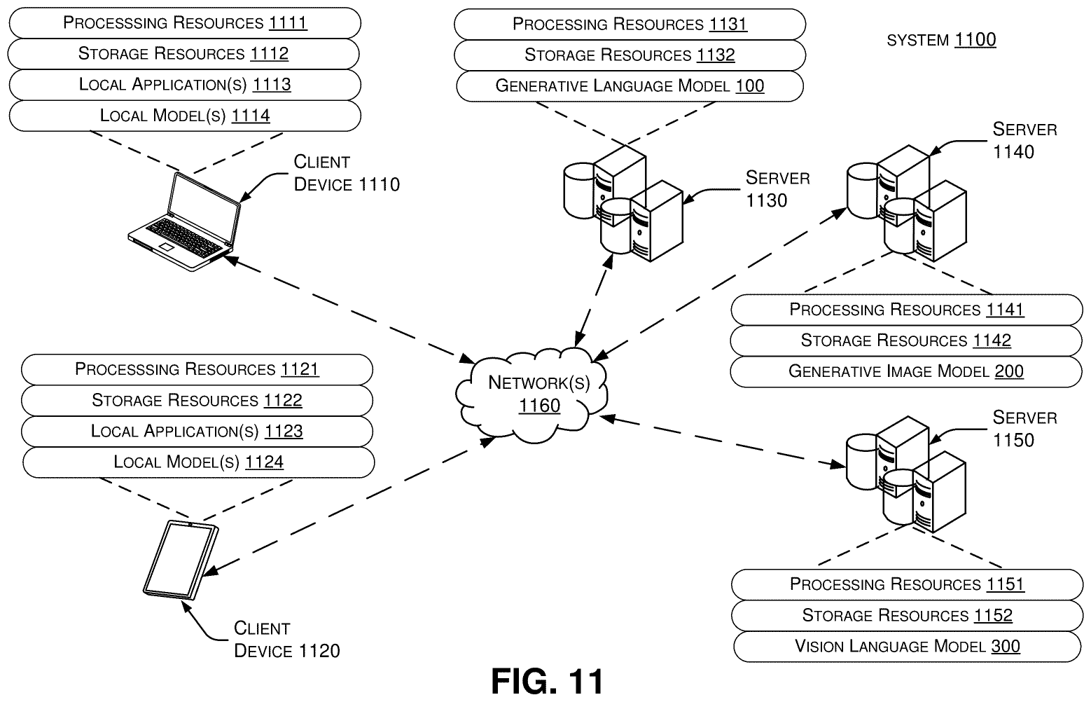

The present implementations can be performed in various scenarios on various devices. FIG. 11 shows an example system 1100 in which the present implementations can be employed, as discussed more below.

As shown in FIG. 11, system 1100 includes a client device 1110, a client device 1120, a server 1130, a server 1140, and a server 1150, connected by one or more network(s) 1160. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 11, but particularly the servers, can be implemented in data centers, server farms, etc.

Client device 1110 can have processing resources 1111 and storage resources 1112, client device 1120 can have processing resources 1121 and storage resources 1122, server 1130 can have processing resources 1131 and storage resources 1132, server 1140 can have processing resources 1141 and storage resources 1142, and server 1150 can have processing resources 1151 and storage resources 1152. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 1110 can include one or more local application(s) 1113 and one or more local models 1114. For instance, a local application can provide a graphical interface such as GUI 1000, and can also access one or more image repositories to allow a user to select input images for subsequent generation. In some cases, the local application can also coordinate image generation by prompting and/or invoking various local or remote models. Client device 1120 can include one or more local application(s) 1123 and one or more local models 1124 that can function similarly to local application(s) 1113.

Server 1130 can host generative language model 100, server 1140 can host generative image model 200, and server 1150 can host vision language model 300. These models can output generated language, generated images, and/or generated computer vision results, respectively, in response to requests from the local application(s) on the client devices. For instance, in some implementations, image generation pipeline 400 is implemented entirely on a client device by a local application that coordinates communications with remote models. In other implementations, image generation pipeline 400 is implemented remotely from the client devices by a web service. In still further implementations, some or all of machine learning processing described herein is performed by local models on the respective client devices.

### Example Method

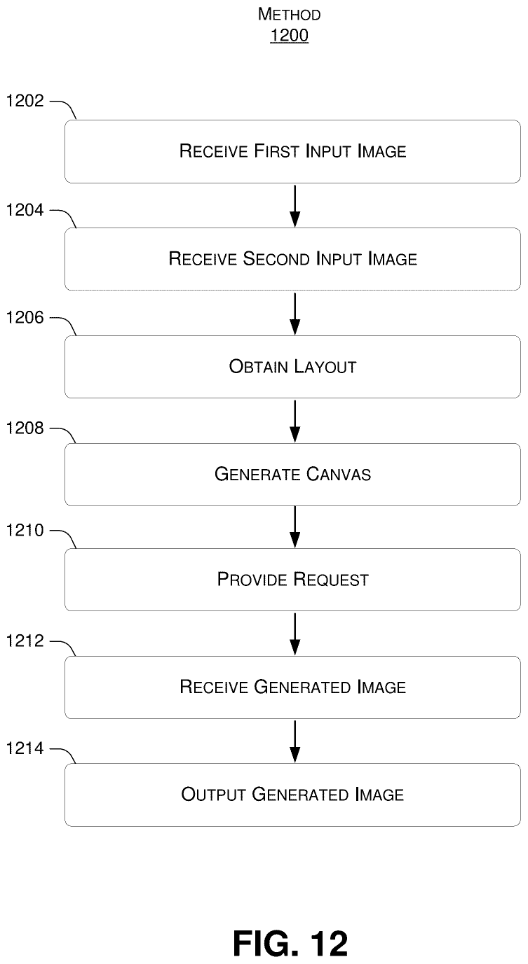

FIG. 12 illustrates an example computer-implemented method 1200, consistent with some implementations of the present concepts. Method 1200 can be implemented on many different types of devices, e.g., by one or more cloud servers, by a client device such as a laptop, tablet, or smartphone, or by combinations of one or more servers, client devices, etc.

Method 1200 begins at block 1202, where a first input image is received. For instance, the first input image can depict a first object for use in subsequent image generation. In some cases, the first object can be shown in isolation (e.g., against a neutral background), and in other cases can be shown with other objects and/or with a more complex background.

Method 1200 continues at block 1204, where a second input image is received. For instance, the second input image can depict a second object for use in subsequent image generation. In some cases, the second object can be shown in isolation (e.g., against a neutral background), and in other cases can be shown with other objects and/or with a more complex background.

Method 1200 continues at block 1206, where a layout is obtained. For instance, the layout can specify locations, sizes, depths, and/or orientations of the first object and the second object. As noted previously, the layout can be obtained using a number of techniques. One such technique involves providing in-context examples of layouts to a generative language model with a prompt requesting a layout of the first object and the second object. Another technique involves generating the layout with a machine learning model that has been trained to learn arrangements of objects from a repository of real or synthetically-generated training examples.

Method 1200 continues at block 1208, where a canvas is generated from the layout. For instance, the canvas can be generated by positioning the first object and the second object according to the layout. The remainder of the canvas can be masked to indicate the area that will be subsequently inpainted.

Method 1200 continues at block 1210, where a request to inpaint the canvas is provided to a generative image model. For instance, the request can be provided as a prompt that specifies information such as a background or scene in which to place the objects (e.g., a living room, library, bedroom, etc.). In some cases, the prompt can also specify a theme, e.g., in the examples above, the themes included Christmas, Halloween, and Easter.

Method 1200 continues at block 1212, where the generated image is received. For instance, the generated image can be a static two-dimensional image, a static three-dimensional image, a two-dimensional video, a three-dimensional video, etc.

Method 1200 continues at block 1214, where the generated image is output. For instance, the generated image can be displayed on a client device of a user that selected the first input image, the second input image, and/or the theme. In other cases, the generated image is sent over a network for display on another device.

In some cases, some or all of method 1200 is performed by a server. In other cases, some or all of method 1200 is performed on another device, e.g., a client device, or distributed across multiple devices.

### Additional Implementations

The examples described above convey the disclosed concepts using two-dimensional input images to generate two-dimensional output images. However, the present concepts can also be employed with three-dimensional images. For instance, consider a scenario where three-dimensional models of objects are available. The objects can be captured from different viewpoints to depict different views of the objects. Thus, it is plausible to render the objects in a three-dimensional generated scene that allows changing viewpoints to view different portions of the objects. The objects can be located in the three-dimensional scene based on a three-dimensional layout. This would allow a user to move within a three-dimensional generated scene and see the objects from different viewpoints in a natural and authentic manner, while preserving the original appearance of the objects. Additional details on generating composite three-dimensional spaces can be found in U.S. patent application Ser. No. 18/756,717, Atty Docket No. 502114-US01, “Creating Virtual Three-Dimensional Spaces Using Generative Models,” filed Jun. 27, 2024, which is incorporated herein by reference in its entirety.

In still further implementations, videos can be generated instead of static images. For instance, consider objects that tend to move, such as a basketball and basketball players, and other objects that tend to remain stationary, such as basketball hoops and seating in an arena. A layout could be generated that specifies static locations of two hoops and arena seating, while generating multiple realistic trajectories for the basketball and players. A video could be generated that shows the basketball and players moving according to the layout-defined trajectories. Multiple videos could be generated with different themes, e.g., the themes could specify a home team and an away team. The generative image model could generate videos with different jerseys and a mural on the court representing the home team. The players, hoops, seating, and basketball could retain their original appearance from one or more input images. In further implementations, audio could be generated concurrently with movement of the players or ball, to produce sounds such as bouncing of the ball or a “swish” sound as the ball goes through the hoop. A three-dimensional video experience could be generated allowing a user to move through the area and view the seating, players, hoops, and basketball from different viewpoints. Directional audio could be rendered to provide realistic sounds, e.g., the sound of a ball can change as the user and ball move relative to one another, becoming louder as they get closer, etc.

Furthermore, note that the previous discussion showed a GUI 1000 where users manually navigate to select individual input images. In further implementations, retrieval-augmented generation (RAG) techniques can be employed. For instance, a user could enter a text prompt such as “Show me a brand ABC sofa in a Halloween-themed living room with a brand XYZ round table.” Image search results can be retrieved to obtain images of a brand ABC sofa and brand XYX round table, respectively. Thus, the user is able to use natural language input to describe the objects they would like to see in the generated image, with RAG being employed to automatically retrieve appropriate images that are employed for subsequent generation.

### Technical Effect

As noted above, generative image models can have certain limitations. For instance, when a generative image model is instructed to inpaint an image with one or more input objects, the generative image model can have a tendency to modify the objects themselves, whereas in some instances it may be important to preserve the original appearance of the objects. Furthermore, generative image models may tend to produce images that convey unrealistic size relationships between objects, e.g., one object may be far too large relative to another. In addition, generative image models may fail to generate realistic placements of objects, e.g., a bowl may be shown under a table instead of on top of the table.

The disclosed implementations can obviate these issues by guiding image generation according to a layout that specifies locations and sizes of multiple objects. By enforcing constraints such as retaining edges or depths of the objects from the generated layouts, the resulting generated images will show the objects with their original appearance, sized and placed realistically within an environment. Users can provide themes to adjust how the remainder of the environment appears in the generated image, thus allowing users to experiment with different themes for the inpainted portion of the final image.

Thus, the disclosed techniques can result in improved human-computer interaction by reducing the input burden on the user. The user does not need to provide separate inputs defining where to place individual objects, sizes of the objects, or image generation constraints to preserve the original appearance of the objects. Instead, the disclosed implementations can determine specific pixel locations and object sizes widths, heights, etc. for objects and control image generation so that the pixel locations and object sizes are retained during image generation. Furthermore, enforcing edge and or depth constraints from a generated layout can ensure that the objects are depicted in appropriate locations in the final generated images.

### Device Implementations

As noted above with respect to FIG. 11, system 1100 includes several devices, including a client device 1110, a client device 1120, a server 1130, a server 1140, and a server 1150. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signal. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 1160. Without limitation, network(s) 1160 can include one or more local area networks (LANs), wide area networks (WANs), the Internet, and the like.

Various examples are described above. Additional examples are described below. One example includes a computer-implemented method comprising receiving a first input image depicting a first object, receiving a second input image depicting a second object, obtaining a layout specifying a first location of the first object and a second location of the second object, generating a canvas having the first object in the first location and the second object in the second location, providing, to a generative image model, a request to inpaint the canvas while retaining the first object and the second object, receiving a generated image from the generative image model, and outputting the generated image.

Another example can include any of the above and/or below examples where the computer-implemented method further comprises filtering, from image generation, pairs of other images of that have incompatible viewpoints with respect to one another.

Another example can include any of the above and/or below examples where the filtering involves instructing the generative image model to inpaint floors in the other images, reconstructing floor planes from the inpainted floors, and estimating vectors representing directions of the floor planes, wherein the filtering is based at least on the vectors.

Another example can include any of the above and/or below examples where the computer-implemented method further comprises performing segmentation on the first input image resulting in a first segmentation of the first object, and performing segmentation on the second input image resulting in a second segmentation of the second object.

Another example can include any of the above and/or below examples where the computer-implemented method further comprises inputting the first input image and the second input image to a vision language model, and receiving, from the vision language model, a first label of the first object and a second label of the second object.

Another example can include any of the above and/or below examples where the performing segmentation comprises inputting the first label with the first input image and the second label with the second input image to a segmentation model, and receiving the first segmentation and the second segmentation from the segmentation model.

Another example can include any of the above and/or below examples where the computer-implemented method further comprises determining a first size of the first object and a second size of the second object, and producing the layout based at least on the first size and the second size.

Another example can include any of the above and/or below examples where determining the first size comprises extracting the first size from metadata or text associated with the first input image, providing a link associated with the first object to a generative language model that outputs the first size, or estimating the first size using a depth estimation model.

Another example can include any of the above and/or below examples where obtaining the layout comprises requesting a layout generation model to produce the layout.

Another example can include any of the above and/or below examples where the computer-implemented method further comprises obtaining a layout generation prompt from a generative language model, and inputting the layout generation prompt to the layout generation model.

Another example can include any of the above and/or below examples where the layout is based on arrangements of other objects in an image repository.

Another example can include any of the above and/or below examples where the computer-implemented method further comprises instructing the generative image model to control image generation based at least on edges of the first object and the second object in the canvas.

Another example can include any of the above and/or below examples where the computer-implemented method further comprises instructing the generative image model to control image generation based at least on depths of the first object and the second object in the canvas.

Another example can include any of the above and/or below examples where the computer-implemented method further comprises receiving a theme for the generated image, and instructing the generated image to generate the image based at least on the theme.

Another example can include any of the above and/or below examples where the generated image is a static, two-dimensional image.

Another example can include any of the above and/or below examples where the generated image is a video.

Another example can include any of the above and/or below examples where the generated image is three-dimensional.

Another example can include a system comprising a processor, and a storage medium storing instructions which, when executed by the processor, cause the system to receive a first input image depicting a first object, receive a second input image depicting a second object, obtain a layout specifying a first location of the first object and a second location of the second object, generate a canvas having the first object in the first location and the second object in the second location, provide, to a generative image model, a request to inpaint the canvas while retaining the first object and the second object, receive a generated image from the generative image model, and output the generated image.

Another example can include any of the above and/or below examples where the instructions, when executed by the processor, cause the system to instruct the generative image model to retain at least one of edges or depths of the first object and the second object when inpainting the canvas.

Another example can include a computer-readable storage medium storing instructions which, when executed by a processing device, cause the processing device to perform acts comprising receiving a first input image depicting a first object, receiving a second input image depicting a second object, obtaining a layout specifying a first location of the first object and a second location of the second object, generating a canvas having the first object in the first location and the second object in the second location, providing, to a generative image model, a request to inpaint the canvas while retaining the first object and the second object, receiving a generated image from the generative image model, and outputting the generated image.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving a first input image depicting a first object;
receiving a second input image depicting a second object;
obtaining a layout specifying a first location of the first object and a second location of the second object;
generating a canvas having the first object in the first location and the second object in the second location;
providing, to a generative image model, a request to inpaint the canvas while retaining the first object and the second object;
receiving a generated image from the generative image model; and
outputting the generated image.

2. The computer-implemented method of claim 1, further comprising:
filtering, from image generation, pairs of other images of that have incompatible viewpoints with respect to one another.

3. The computer-implemented method of claim 2, wherein the filtering involves:
instructing the generative image model to inpaint floors in the other images;
reconstructing floor planes from the inpainted floors; and
estimating vectors representing directions of the floor planes,
wherein the filtering is based at least on the vectors.

4. The computer-implemented method of claim 1, further comprising:
performing segmentation on the first input image resulting in a first segmentation of the first object; and
performing segmentation on the second input image resulting in a second segmentation of the second object.

5. The computer-implemented method of claim 4, further comprising:
inputting the first input image and the second input image to a vision language model; and
receiving, from the vision language model, a first label of the first object and a second label of the second object.

6. The computer-implemented method of claim 5, wherein the performing segmentation comprises:
inputting the first label with the first input image and the second label with the second input image to a segmentation model; and
receiving the first segmentation and the second segmentation from the segmentation model.

7. The computer-implemented method of claim 1, further comprising:
determining a first size of the first object and a second size of the second object; and
producing the layout based at least on the first size and the second size.

8. The computer-implemented method of claim 7, wherein determining the first size comprises:
extracting the first size from metadata or text associated with the first input image;
providing a link associated with the first object to a generative language model that outputs the first size; or
estimating the first size using a depth estimation model.

9. The computer-implemented method of claim 1, wherein obtaining the layout comprises requesting a layout generation model to produce the layout.

10. The computer-implemented method of claim 9, further comprising:
obtaining a layout generation prompt from a generative language model; and
inputting the layout generation prompt to the layout generation model.

11. The computer-implemented method of claim 1, wherein the layout is based on arrangements of other objects in an image repository.

12. The computer-implemented method of claim 1, further comprising:
instructing the generative image model to control image generation based at least on edges of the first object and the second object in the canvas.

13. The computer-implemented method of claim 1, further comprising:
instructing the generative image model to control image generation based at least on depths of the first object and the second object in the canvas.

14. The computer-implemented method of claim 1, further comprising:
receiving a theme for the generated image; and
instructing the generated image to generate the image based at least on the theme.

15. The computer-implemented method of claim 1, wherein the generated image is a static, two-dimensional image.

16. The computer-implemented method of claim 1, wherein the generated image is a video.

17. The computer-implemented method of claim 1, wherein the generated image is three-dimensional.

18. A system comprising:
a processor; and
a storage medium storing instructions which, when executed by the processor, cause the system to:
receive a first input image depicting a first object;
receive a second input image depicting a second object;
obtain a layout specifying a first location of the first object and a second location of the second object;
generate a canvas having the first object in the first location and the second object in the second location;
provide, to a generative image model, a request to inpaint the canvas while retaining the first object and the second object;
receive a generated image from the generative image model; and
output the generated image.

19. The system of claim 18, wherein the instructions, when executed by the processor, cause the system to:
instruct the generative image model to retain at least one of edges or depths of the first object and the second object when inpainting the canvas.

20. A computer-readable storage medium storing instructions which, when executed by a processing device, cause the processing device to perform acts comprising:
receiving a first input image depicting a first object;
receiving a second input image depicting a second object;
obtaining a layout specifying a first location of the first object and a second location of the second object;
generating a canvas having the first object in the first location and the second object in the second location;
providing, to a generative image model, a request to inpaint the canvas while retaining the first object and the second object;
receiving a generated image from the generative image model; and
outputting the generated image.
